(19) United States
(12) Patent Application Publication
(10) Pub. No.: US 2016/0159422 A1
(43) Pub. Date: Jun. 9, 2016

(54) Original Ball & Sports Rack

(71) Applicant: Rory Davis, Lynwood, CA (US)

(72) Inventor: Rory Davis, Lynwood, CA (US)

(21) Appl. No.: 14/560,853

(22) Filed: Dec. 4, 2014

(51) Int. Cl. B62J 9/00; B62J 11/00; B62J 7/04; A63B 47/00

(52) U.S. Cl. CPC B62J 9/001; A63B 47/00; B62J 11/00; B62J 7/04

(57) ABSTRACT

Rory Davis, 40, has worked in retail since he was 15 and is currently a Manager Assistant at Walgreen's. He loves to be outdoors and enjoys fishing, basketball, racquetball, hiking and tennis.

Mr. Davis was inspired to develop this idea as a result of warning to ride his bike to the park to play basketball. He realized this wasn't feasible, as there was no way to carry the ball with him as he rode. He has been formulating the BALL RACK idea for a year and a half. The inventor has shared the concept with all his family, and has their full support.

Following is physical description of the BALL RACK, designed to properly characterize the working functions of the product as well as define the physical appearance. Based on the inventor's description and any pertinent additional research, typical use of the product, its basic design and production materials are considered. In the next section, any possible modifications in use or design suggested by the inventor or Invent-Tech's consultants are explored, along with overall production feasibility.

The BALL RACK can be made of sturdy plastic or a lightweight metal such as aluminum. Designed to provide bicyclists with an enclosed basket for carrying basketballs, footballs, soccer balls, and the like, the BALL RACK attaches to the seat post and ensures that balls can be biked to sporting events safely and securely (FIG. 4). A metal ring clamp (or similar) attaches to the seat pole of the bike, with a tension screw on one or both sides for tightening (FIG. 3). Extended from the attachment ring (over the back wheel) is a ¼″ to ¼″ thick metal pole approximately 18″ long (FIG. 2).

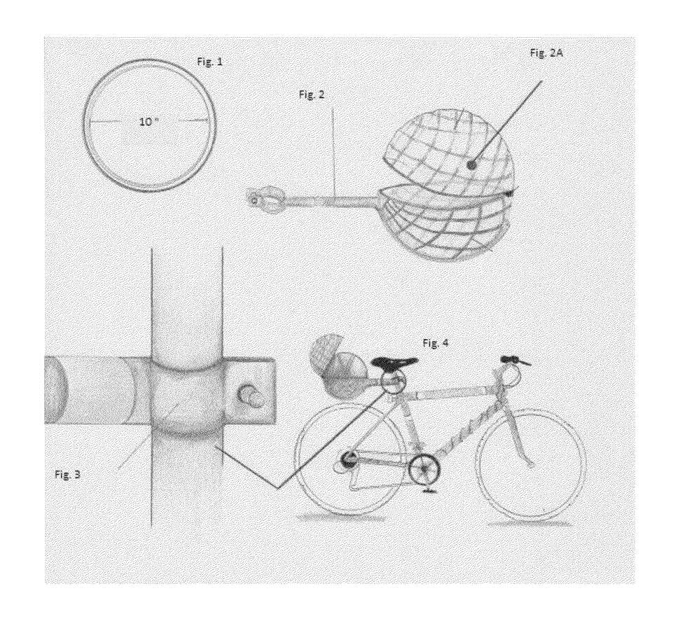

At the end of this pole is the BALL RACK metal mesh basket, which is Approximately 10″ in diameter (FIG. 1)

The basket has a domed, hinged cover that can be latched closed to securely contain items place inside (FIG. 2A). A chrome-like finish is envisioned for the BALL RACK, although the inventor notes that various colors could be produced to match or coordinate with bike paint finishes.

Please note the design sketch at the end of this section for a more complete representation of this design.

As discussed below, the design parameters for this product are amenable to current production processes and tooling and the materials specified are commonly available on the commercial level.

Due to the BALL RACK'S very simple components, it should be no problem to produce from any technical standpoint. Existing assembly lines could easily be adapted for its speedy manufacture.

### BRIEF DESCRIPTION OF DRAWINGS

(FIG. 1)—BALL RACK metal mesh basket, which is approximately 10″ in diameter

(FIG. 2)—a ¼″ to ¼″ thick metal pole approximately 18″ long. p (FIG. 2A)—The basket has a domed, hinged cover that can be latched

(FIG. 3)—A metal ring clamp (or similar) attaches to the seat pole of the bike, with a tension screw on one or both sides for tightening

(FIG. 4)—the BALL RACK attaches to the seat post and ensures that balls can be biked to sporting events safely and securely

In assessing any new product's future acceptance, popularity and utilitarian uses, a conscientious review of the existing need or market for the innovation must be undertaken. What benefits can be obtained through consumer application of this product? What specific target markets would stand to benefit from such solutions?

In the case of the BALL RACK, the primary benefits provided by the product include, but are not limited to, the convenience, utility, economy, and safety offered by a product designed to provide bicyclists with an enclosed basket for carrying basketballs, footballs, soccer balls, and the like. The BALL RACK attaches to the seat post and ensures that balls can be biked to sporting events safely and securely. Unlike open topped front baskets, the BALL RACK will have a hinged lid or cover to keep balls from falling or bouncing our during transit. It allows you to have the full benefit of the warm-up exercise and fun of biking to ball games and practices without the hassle and danger of trying to carry sports equipment in one hand while you do so. This product is easy to use and affordable, and should quickly recommend itself to a wide consumer base.

1. The Product Market for the BALL RACK will be consumers who enjoy bike riding but want a better way to carry sports balls to parks, ball fields, games, practice, and the like.
Given the design advantages of this product, its utility and convenience are immediately evident. Economical and practical, it should have no trouble tapping into this huge and lucrative market.
